(19) United States
(12) Patent Application Publication
(10) Pub. No.: US 2024/0314037 A1
(43) Pub. Date: Sep. 19, 2024

(54) SYSTEM AND METHOD FOR DYNAMIC SELF-CONFIGURATION OF NETWORK DEVICE DATA COLLECTION

(71) Applicant: TOSHIBA TEC KABUSHIKI KAISHA, Tokyo (JP)

(72) Inventor: Louis M. Ormond, Irvine, CA (US)

(21) Appl. No.: 18/122,075

(22) Filed: Mar. 15, 2023

(51) Int. Cl. H04L 41/12

(52) U.S. Cl. CPC H04L 41/12

(57) ABSTRACT

A system and method for dynamic self-configuration for network data collectors includes one or more networked devices, suitably multifunction peripherals, which are designated as network data collectors for other networked devices. Each designated data collector determines its own network address and defines a subnet of proximate network addresses, such as addresses within a defined address range. Addresses within the defined subnet are checked and a device list is formed identifying each address associated with a detected device for which data collection is desired. Data collectors supplement the address range to include addresses associated with related networks retrieved from a cloud server. Addresses within an address range associated with related networks are checked and devices detected for data collection are added to the device list. Device lists are refreshed periodically in a similar fashion.

### TECHNICAL FIELD OF THE INVENTION

This application relates generally to monitoring of networked printing devices. The application relates more particularly to assigning a device to be a data collector wherein the data collector automatedly discovers networked devices for periodic acquisition of device state information.

### BACKGROUND OF THE INVENTION

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Multiple MFPs are typically placed in a business' network for shared use among employees. In larger companies, MFPs may be housed in different locations, such as different floors or different buildings. MFPs have many moving parts that are subject to wear and failure. MFPs use consumables such as toner, ink, or paper, which must be periodically replenished. Device maintenance may be triggered by an emergent error condition, or anticipated by usage levels, such as a page count. Error conditions may be detected by embedded sensors, such as temperature sensors or paper jam sensors. MFPs will periodically be subject to software or firmware updates, additions or modifications.

### BRIEF DESCRIPTION OF THE DRAWINGS

Various embodiments will become better understood with regard to the following description, appended claims and accompanying drawings wherein:

FIG. 1 is an example embodiment of a system for dynamic self-configuration of network device data collection;

FIG. 2 is an example embodiment of a networked digital device;

FIG. 3 is an example embodiment of a digital device system; and

FIG. 4 is an example embodiment of a flowchart for dynamic self-configuration of network device data collection

### DETAILED DESCRIPTION OF THE INVENTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

MFP maintenance, such as that noted above, can be assisted by network device monitoring. An example is provided with Toshiba TEC's e-Bridge Cloud Connect system (ECC). ECC is implemented as a web-based device management system that facilitates real-time monitoring of technical alerts and warnings, remote device configuration and software changes, and accumulation of service data for problem diagnosis and problem resolution.

In earlier MFP device maintenance systems, one or more networked MFPs are designated and configured as data collectors. Data collectors are manually configured wherein a service technician sets an IP address or range of IP addresses for each data collector. This requires the service technician to get information from their customer related to the network IP addresses. The service team must then manually input the IP configuration into each data collector individually. This process is labor intensive, tedious, time consuming, and potentially error prone since the IP address data is managed manually.

Once each data collector has been configured, an associated local area network (LAN), is polled to identify devices. Once identified, device data collection is periodically undertaken. Devices often store pertinent information in an associated database. A database may be in the form of a management information base (MIB) that is accessible via Simple Network Management Protocol (SNMP).

Example embodiments herein provide for automated and dynamic collector self-configuration for accuracy enhanced data collection. Locally hosted data collector agents self-configure an applicable LAN IP addresses based on the host systems IP address and cloud-based data analysis. A data collector's host device's IP address is used as an initial reference. This data is be used to create a scan IP address range. The data collector also communicates with a cloud server having pre-stored device information. The cloud server analyze its database for other devices on a common LAN using customer information. This is done to determine if other devices from the same customer are using separate IP subnets.

Combined local and cloud IP ranges are used by the data collector to scan for available devices. A resulting dataset is saved and reused to speed network scan processing in subsequent scans. The process is periodically reinitiated to determine if new IP ranges need to be evaluated for available devices.

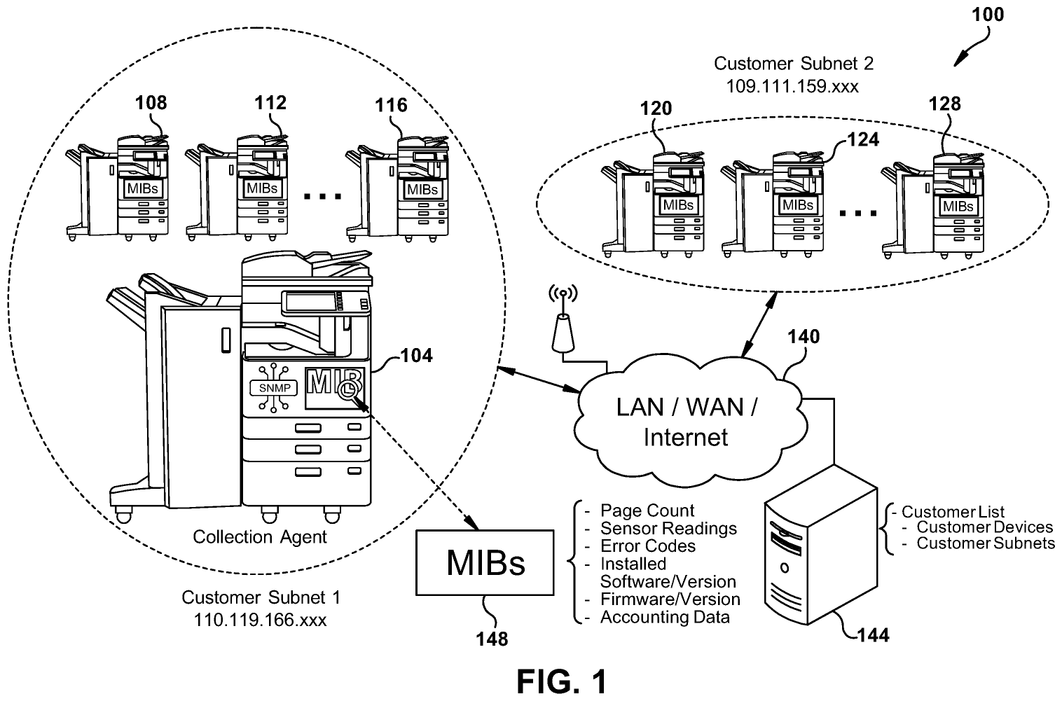

FIG. 1 illustrates an example embodiment of a system 100 for dynamic self-configuration of network device data collection. Included is a group of one or more networked MFPs. In the illustrated example, MFPs 104, 108, 112 and 116 reside in Customer Subnet 1, while MFPs 120, 124 through 128 reside in Customer Subnet 2. Included in FIG. 1 is network cloud 140, suitably comprised of a local area network (LAN), a wide area network (WAN), which may comprise the Internet, or any suitable combination thereof. Network cloud 140 is comprised of any suitable wireless or wired data connection or combination thereof.

One or more MFPs are designated as data collectors. In the illustrated example, MFP 104 of Customer Subnet 1 has been designated and configured as a data collector for Customer Subnet 1. MFP 104 as a data collector determines a subnet range that encompasses its own network address. Such range may be determined by a fixed number of addresses of fixed range of addresses for devices having addresses proximate to the address of MFP 104. MFP 104 as a data collector then checks addresses in a determined range to discover network devices, particularly network devices for which data reporting is desired. In the illustrated example, MFPs 108, 112 through 116 of Customer Subnet 1 fall within the determined range.

MFP 104 may also be tasked with collecting from other network devices that fall outside of its determined address range. Device information, such as devices associated with a common customer, is suitably stored in network server 144. Such information may comprise customer identification and associated device information, such as different device addresses, subnets or address ranges for which device collection by MFP 104 is desired. MFP 104 as a data collector may then determine one or more address ranges relative to retrieved device information and discover devices to be monitored accordingly. In the illustrated example, network server 144 provides information relative to Customer Subnet 2 for which MFP 104 is also designated for collection. MFP 104 then discovers MFPs 120, 124 through 128.

MFP 104 as a data collector stores a device list identifying addresses of each discovered device in all networks assigned to it for collection. MFP 104 periodically queries discovered devices for device state information, suitably using MIB information 148 acquired via SNMP, and aggregates acquired data for reporting and analysis. MIB information may comprise any information of interest. In the case of MFPs, MIB information may include device status data such as page count, or device sensor readings, such as toner or ink levels, paper levels, device operation time or device operating environment. MIB information may also include device error codes, installed software, version of installed software, installed firmware and its associated version, as well as accounting information such as device usage charges.

MFP 104 as a data collector periodically repeats the device discovery operation to refresh or update its device list for future data collection.

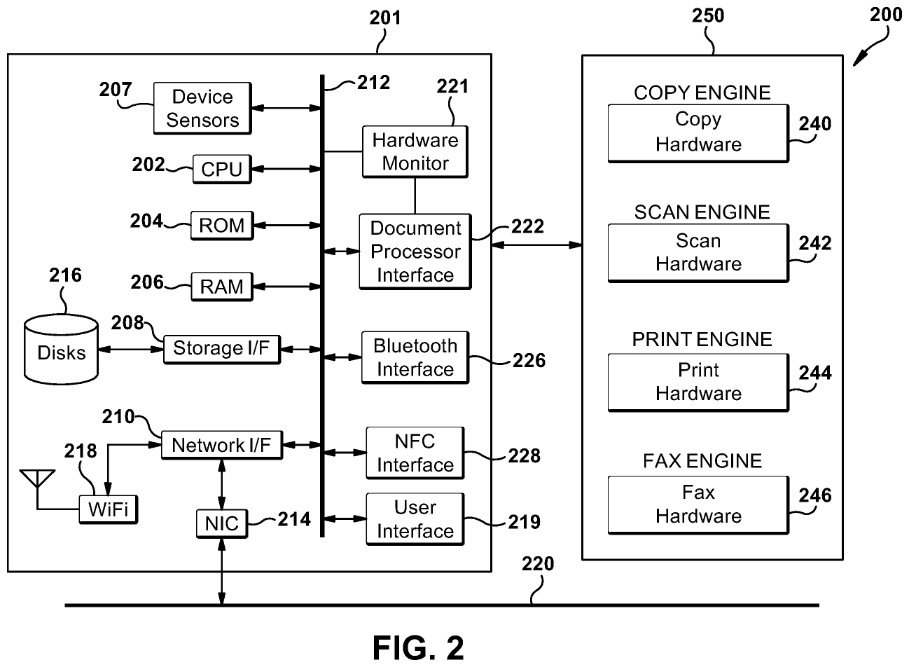

Turning now to FIG. 2, illustrated is an example embodiment of a networked digital device comprised of document rendering system 200 suitably comprised within an MFP, such as with the MFPs of FIG. 1. It will be appreciated that an MFP includes an intelligent controller 201 which is itself a computer system. Thus, an MFP can itself function as a server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with input/output interface 222, suitably comprising a user touchscreen. While touchscreens are discussed in example embodiments herein, it is to be appreciated that any suitable user interface, such as keyboards, switches, displays, trackballs or mice may be used.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with additional interfaces, such as Bluetooth interface 226 and NFC interface 228

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless network interfaces include optical, cellular, Wi-Fi, wireless universal serial bus (wireless USB), satellite, and the like. Example wired interfaces include Ethernet, USB, IEEE 1394 (FireWire), Lightning, telephone line, or the like.

Processor 202 can also be in data communication with any suitable user input/output (I/O) network interface 219 which provides data communication for interfacing with user peripherals, such as displays, keyboards, mice, track balls, touch screens, or the like. Processor 202 can also be in communication with hardware monitor 221, such as a page counter, temperature sensor, toner or ink level sensor, paper level sensor, or the like.

Also in data communication with data bus 212 is a document processor interface 222 suitable for data communication with the document rendering system 250, including MFP functional units. In the illustrated example, these units include a copy engine comprising copy hardware 240, a scan engine comprise of scan hardware 242, a print engine comprised of print hardware 244 and a fax engine comprised of fax hardware 246 which together comprise document rendering system 250. It will be understood that functional units are suitably comprised of intelligent units, including any suitable hardware or software platform.

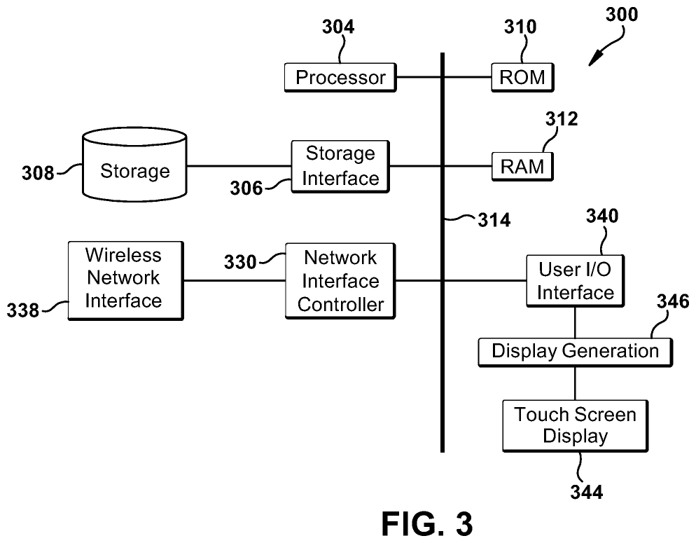

Turning now to FIG. 3, illustrated is an example embodiment of a digital data processing device 300 such as network server 144 of FIG. 1. It is to be appreciated that some components listed may be unnecessary in certain configurations. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. Data communication among components is accomplished via data bus 314. A network interface controller 330 suitably provides a gateway for data communication with other devices, via any wireless or wired connection, such as via wireless network interface 338. A user input/output interface 340 is suitably comprised of display generator 346 interfacing with touchscreen display 344. As noted above, any suitable user input and display can be used.

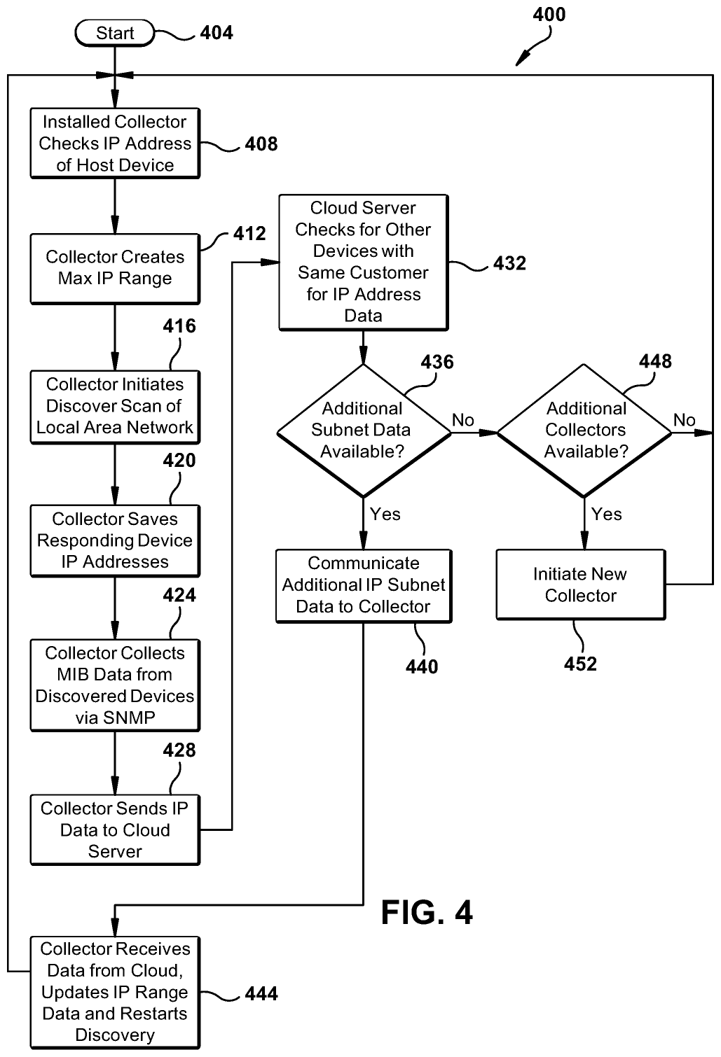

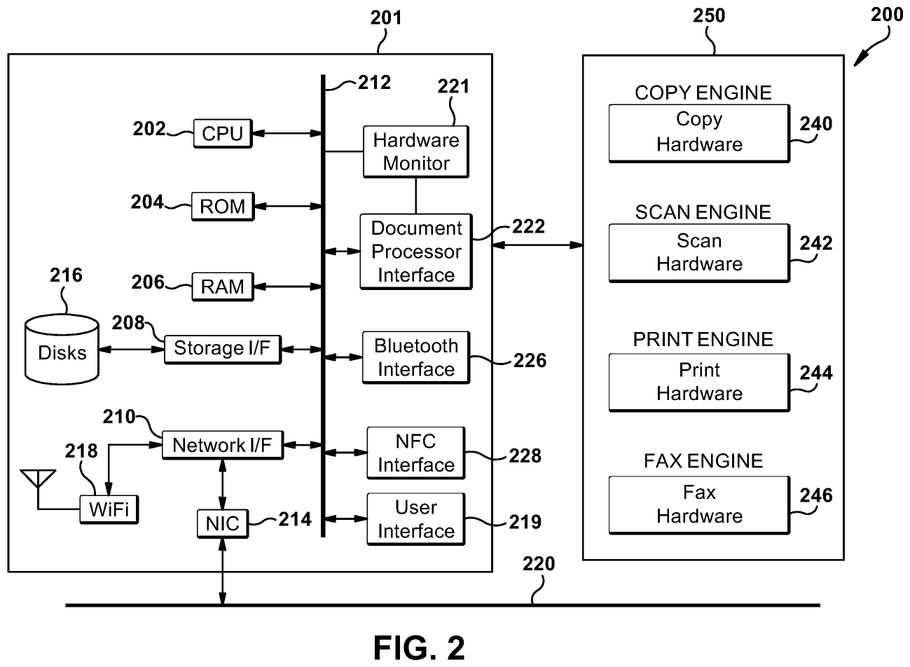

FIG. 4 illustrates an example embodiment of a flowchart 400 for dynamic self-configuration of network device data collection. The system commences at block 404 and proceeds to block 408 where a designated data collector determines its own address, such as its own IP address. The collector then creates a maximum IP range at block 412 for location of network devices. Next, the collector initiates a discover scan for the address range, comprised of a local area network address range in the example, at block 416. The collector then saves a list of IP addresses associated with discovered devices at block 420. MIB data is then collected from devices in the list at block 424.

Next, at block 428, the collector sends discovered IP data to a cloud server. At block 432, the cloud server checks for other devices or network addresses for data collection, such as information devices or networks for a common customer. A test is made at block 436 to determine if additional subnets are to be scanned. If so, additional IP subnet information is communicated to the collector at block 440, and this information is received and address information updated by the collector at block 444. The process then returns to block 408.

If a determination is made at block 436 that no additional subnet information is available on the server, a test is made at block 448 to determine if any additional data collectors have been designated. If not, the process is returned to block 408. If so, any new data collector is initiated at block 452 and the process proceeds to block 408 for each data collector.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a processor and associated memory;
a network interface having an associated network address;
the processor configured to determine an address range proximate to the associated network address;
the processor further configured to check each address in the address range to identify document processing devices and their associated addresses;
the processor further configured collect status data from each identified document processing device;
the processor further configured to receive device information from an associated cloud server identifying additional document processing devices associated with identified document processing devices;
the processor further configured to determine one or more additional address ranges in accordance with address information associated with received device information;
the processor further configured to check each address in each additional address range to identify additional document processing devices and their associated addresses; and
the processor further configured to collect status data from each additional document processing device.

2. (canceled)

3. The system of claim 1 wherein the processor is further configured to store a device list including address information associated with each document processing device.

4. The system of claim 3 wherein the processor is further configured to periodically collect updated status data from each document processing device in the device list.

5. The system of claim 4 wherein the processor is further configured to periodically:
perform an updated check of each address in the address range to update the identified document processing devices and their associated addresses;
receive updated device information from a cloud server identifying an updated list of additional document processing devices associated with updated identified document processing devices;
determine one or more updated additional address ranges in accordance with address information associated with received updated device information;
check each address in each updated additional address range to generate an updated list identifying additional document processing devices and their associated addresses; and
update the device list in accordance with the list of updated identified document processing devices and updated list of the additional document processing devices.

6. The system of claim 4 wherein each address range is associated with a network subnet.

7. The system claim 5 wherein the status data is comprised of management information base (MIB) data obtained via simple network management protocol (SNMP).

8. The system of claim 6 wherein the processor is further configured to aggregate MIB data as aggregated MIB data and to communicate the aggregated MIB data to an associated device management system via the network interface.

9. A method comprising:
determining, via a processor, an address range proximate to a network address associated with a network interface;
checking each address in the address range to identify document processing devices and their associated addresses;
collecting status data from each identified document processing device;
receiving device information from an associated cloud server identifying additional document processing devices associated with identified document processing devices;
determining one or more additional address ranges in accordance with address information associated with received device information;
checking each address in each additional address range to identify additional document processing devices and their associated addresses; and
collecting status data from each additional document processing device.

10. (canceled)

11. The method of claim 9 further comprising storing a device list including address information associated with each document processing device.

12. The method of claim 11 further comprising periodically collecting updated status data from each document processing device in the device list.

13. The method of claim 12 further comprising:
performing an updated check of each address in the address range to update the identified document processing devices and their associated addresses;
receiving updated device information from a cloud server identifying an updated list of additional document processing devices associated with updated identified document processing devices;
determining one or more updated additional address ranges in accordance with address information associated with received updated device information;
checking each address in each updated additional address range to generate an updated list identifying additional document processing devices and their associated addresses; and
updating the device list in accordance with the list of updated identified document processing devices and updated list of the additional document processing devices.

14. The method of claim 13 wherein each address range is associated with a network subnet.

15. The method claim 14 wherein the status data is comprised of management information base (MIB) data obtained via simple network management prototocol (SNMP).

16. The method of claim 15 further comprising aggregating MIB data as aggregated MIB data and to communicate the aggregated MIB data to an associated device management system via the network interface.

17. A system comprising:
an intelligent controller including a processor and associated memory; and
a network interface;
the intelligent controller configured to,
determine a network address associated with the network interface,
determine a subnet associated with a determined network address,
poll addresses in the subnet to discover document processing devices in the subnet,
request, from a cloud server via the network interface, device information regarding additional document processing devices associated with discovered document processing devices,
determine one or more additional subnets in accordance with the device information received from the cloud server,
poll addresses in the one or more additional subnets to discover the additional document processing devices,
store a device list for each discovered document processing device, and
periodically obtaining device status information from each document processing device in the device list.

18. The system of claim 17 further comprising periodically updating the device list in accordance with re-polling addresses in one or more subnets and updated device information received from the cloud server.

19. The system of claim 18 wherein the device status information includes management information base (MIB) data received via simple network management protocol (SNMP).

20. The system of claim 19 wherein the MIB data includes one or more of a page count, error log, sensor data or accounting data address.
